(19) United States
(12) Patent Application Publication
(10) Pub. No.: US 2007/0067459 A1
(43) Pub. Date: Mar. 22, 2007

(54) Website that assigns visitors to area networks

(75) Inventor: Gal Baal-Haness, Netanya (IL)

Correspondence Address: Gal Baal-Haness, 26 Nili Street #1, Netanya, 42382, IL

(73) Assignee: Gal Baal-Haness, Netanya (IL)

(21) Appl. No.: 11/530,536

(22) Filed: Sep. 11, 2006

Related U.S. Application Data
(60) Provisional application No. 60/718,190, filed on Sep. 16, 2005.

(51) Int. Cl. G06F 15/173

(52) U.S. Cl. 709/226

(57) ABSTRACT

A method, software, and website to identify the source and entry channel of users as they log in, and then assign them to an Area Network (AN) or segment thereof, providing services that are customized and limited to each such network and the network's users. Users within a specific AN are visible to each other via a chat room interface and can communicate with each other via an AN-restricted chat room and via instant messaging. The website creates a platform for providing customized services by the operator of the system and by third parties, available only to users within the network, and a system for advertising and market data collection. Therefore, under the structure of the present invention, each AN becomes independent of other ANs, each with a unique set of users identified by geography, business relationship, interests, or other common factor(s), and a unique set of business development opportunities.

### BACKGROUND OF THE INVENTION

### Field of the Invention

The present invention relates generally to the field of internet web-based personal communication, applications, and services, wherein visitors to a website participate in chat rooms and instant message activities, and exploit other services provided.

Network Communities

Internet users often find it useful to share opinions and meet users online, and often have business, social, or other interests that are common with other users. By connecting to certain websites that provide chat rooms and instant messaging, the users within that system can meet their needs and share their common areas of interest. Usage of such systems can be for business, social, entertainment purposes, or any other interest.

Web-Based Applications

Web-based applications currently provide the same functionality and the same features to all users without discrimination or segmentation. These applications provide services and information that relate to the company that provides and owns the website. It is impossible to have a generic website that is simultaneously customized to meet the network needs of all visitors. In order to have a specific web-based array of services and information available to an organization's network users, the organization must develop its own internet or intranet application. This solution costs a lot of money and effort from the organization's perspective.

This solution also affects the users as they encounter different applications and different platforms in the various organizations they visit, such as work places, hotels, and cafés. The need for restarting the learning curve over and over again, for each organization, presents a hurdle for users and increases their reluctance to use such applications.

Web-Based Chat Rooms and Instant Messaging

Web-based chat rooms and related instant messaging are open to all users of the entire World Wide Web (WWW), and therefore do not screen potential users and do not put any limit on the type and number of users that participate. This creates chat rooms that are overwhelmed with too many users and messages, and leads to very hard to follow conversations, where the messages are posted and appear at a rate faster than the speed at which the average person can read.

Another problem with these applications is “automatic-bots”, which are scriptable applications that enter the popular chat rooms and put fake messages to draw users to different websites or to commercially promote products. This increases the effect of overflowed chat rooms and decreases the perceived reliability of the chat room users.

Another problem with these applications is the users' complete freedom to deceive other users. Any user of such chat rooms can pretend to belong to a specific group while misleading people, and thus promote a personal or political agenda. This raises opportunities for sex offenders, stalkers, and other criminals to find their victims.

Another problem with these applications is lack of control and lack of enforcement mechanisms over users of these applications. This empowers users that aim to harm and disturb the chat room community by overloading the chat room with inappropriate messages, bad language, and disturbing conversations.

Downloadable Instant Messaging Software

Instant messaging applications are downloadable from the internet and are installed on the user's computer. The problem with these applications is that there are many of them that are not compatible with each other. So a user that installs one company's application can't communicate with another user that has adopted a different company's application. Users are hesitant to download multiple instant messaging applications and install them on their computer, since most users would like to install as few applications as possible to maintain computer performance and hard disk space.

Another problem with such instant messaging applications is that they are based on a “buddy list” (compilation of accepted friends and associates) and the members with which a user can connect are only those that the user has met through other means, assuming they both agreed to allow each other to communicate. These applications don't provide users with a platform to meet new people and communicate outside their “buddy list”.

Network Licensed Chat Room and Instant Messaging Software

These applications are downloadable as freeware, as shareware, or can be purchased. They are software based applications that are installed on the computers of a specific network and provide chat room and instant messaging services to “members”. The problem with these applications is that they are software based, and as is true with instant messaging software they require installation on the computer, which most people are reluctant to do. Another problem is that the best of them charge money per computer license which increases the reluctance to use them.

Another problem with purchased applications is that they are licensed only to the network that paid for the license. So the user that has it installed on a laptop can't use it on different networks that don't have the license. This also prevents the user from meeting new users that don't have the license for that application.

### OBJECTIVES OF THE INVENTION

In view of the foregoing disadvantages inherent in the known methods and applications for the use of network restricted communities, the present invention provides a substantial divergence from custom that satisfies the need for website communities and services based upon Area Networks (ANs).

For various business, social, and location-specific reasons, users of such chat rooms and/or instant messaging services may benefit from the ability to share information, or may have an interest in meeting with each other. As users of the AN, they may also have the need for some combination of services and information provided by the website that is uniquely available to the network of which they are participants. That utility is enhanced when the service has accurately segmented users into groups, each of which is defined by its specific interests, geography/location, association (business, etc.), or other factors, and each of which is delimited as to membership, thus barring entry to potential users that are not truly members of the group for which that AN was established.

Therefore:

The main objective of the present invention is to provide software, a business method, and an internet website that provides ANs by which users with common interest factors and objectives can meet and share information with others on the same AN in real time.

Another objective is to provide an entry portal to such an internet website, and login protocol, that automatically separates entering participants, assigning each to an appropriate internal AN based upon such common interest factors and objectives.

Another objective is to prevent WWW users outside of an AN from using the chat room, instant messaging and other services intended for use by the AN users.

Another objective is to provide a web-based chat room plus instant messaging services that are restricted to the members of their AN.

Another objective is to provide users of an AN with web-based services and information that are related to the organization that owns the AN.

Another objective is to provide AN owners with an easy to use, customizable and standardized platform to provide online services to their network users.

Another objective is to provide users with a single and standardized web-based platform for services and information that relate to the AN in use.

Another objective is to provide users with a single and standardized web-based platform for services and information that can be used in different ANs using the same web based platform, web address and user profile.

Another objective is to define each AN as a target market, characterized by its location, business, social, or other interest or unique factor, thus creating a marketing opportunity for third-party vendors and advertisers.

Another objective is to provide such target markets to appropriate third-party vendors as opportunities by which their products and services can be profitably sold via the present invention to its client populations.

Another objective is to provide a methodology by which the present invention will capture online behaviors of the defined populations within the system, creating a salable database of activities and interests of each of the known and characterized groups within each AN.

Another objective is to make such target markets accessible to appropriate third-party advertisers as opportunities by which their products and services can be more profitably advertised and promoted than via other media, due to the efficiency of the demographics of the known populations within each AN, and its behaviors captured by the system comprising the present invention.

### SUMMARY OF THE INVENTION

The present invention consists of an internet website that requires a user login process and utilizes a script to automatically capture and identify each user's AN, segregating users into groups based upon such AN data. This invention can therefore offer services and applications that are limited only to users within each specific AN, and that are not available to those outside that AN. The website can provide all services available on the internet, tailored to the needs and interest of the specific AN and its users, whether the AN is differentiated by location, business, social, or other criteria. Therefore, paying vendors and advertisers can promote their services and products selectively, and the website can provide third-party services and products for which it's paid, targeting very accurately.

The present invention will provide unique implementations of chat rooms and instant messaging services, which are ordinarily plagued by uncontrolled and undesired entrants including stalkers, spammers, frauds, and similar online entities—all of whom can be managed by entry controls established by the website. In addition to such entry screening, the web application enables the network administrator to customize services related to the network from which the website is logged in.

The AN segmentation can be achieved according to a network identifying characteristic such as the network IP address, sub-network IP address or any other use of the internet networking protocol that provides sufficient data to permit such identification and segmentation.

Once a user logs in to the website, he/she is automatically identified as belonging to a particular network segment, which can be the LAN, WAN, MAN or any part of a logical or physical network, identified by the network protocol or another categorization factor.

As part of an identified segment, the user can view other users on the website that belong to the same segment, or AN. For example, all users that are logged on to the website from the same segment appear on a user list in a web based chat room.

Users within the same segment can post messages only to participants in the chat room dedicated to that segment. These users can also send instant messages and start private chats with users on the same segment.

The invention provides the network administrator or owner with the option to customize services that best fit the needs and interests of the network's users. The website provides a customization application with templates and tools to create a variety of pages with services and information for network users. Such information and services are accessible only by the users under that specific network segment.

### DESCRIPTION OF THE PREFERRED EMBODIMENT

The objective of the present invention is to divide entrants to a website into segments (ANs) based upon common interests, locations, business, or other factors, associated with the internet channel/mechanism by which the user approaches the website. The present invention permits segmentation of users by network IP address, sub network IP address, or any other categorization/identification data useful to create or assign ANs within the system.

The following describes the preferred embodiment, which utilizes the network IP address to achieve segmentation of users into LANs.

The Login Process

The login process creates a database for each different LAN from which the website is used. This process ensures that the services provided under the specific network will be available only to that network's users. Users on each LAN will be able to view and contact only those users that are on the same LAN.

The login process and the application use the network IP address as the basis for network segmentation.

In the login process:

1. The user inserts username or nickname

2. The user clicks on the login button

3. The user's network IP address is automatically sent to the application (chat room, instant messaging, etc.) server

4. If there is a database for that IP address, the username is added to that database

5. If there is no database for that IP address, a database is created for that IP address and the username is added to that database

The Chat Room and the Instant Messaging Service

The preferred embodiment provides an opportunity for users to meet other users that are using the same LAN, with public (within the LAN) chat rooms, instant messaging, and private chat services, configured such that only users that share the same LAN are able to contact each other. The separation between different LANs is done automatically and saved on the application server.

Users on a specific LAN can see only the lobby room of their specific LAN and chat rooms created by users on the same LAN. Users cannot see members and chat rooms outside their LAN.

Following the login process:

1. If a lobby chat room already exists for the user's network IP address, the user is joined to that chat room

2. If a lobby chat room does not exist for this network IP address, a dedicated chat room is created and the user is logged into it

3. Users can open sub-rooms under their LAN's lobby chat room

4. Empty rooms under each LAN's lobby chat room are automatically erased

5. Empty lobby chat rooms are automatically erased if they have no active sub-rooms and no active users

The users can share information on multi-user chat rooms or with private instant messaging service within the network's users.

Customized Services

The preferred embodiment of the present invention provides customizable services that are dedicated to each given network and that are accessible only by that network's users.

In the preferred embodiment, services to be customized by the network owner or administrator can include:

1. Service order—Room service, ordering food, drinks, repair service, etc.

2. Business calendar—Schedules of events for the facility that owns the network

3. News and updates—From the facility that owns the network

4. Customer support

5. Customer feedback

6. Reservation of services

7. Payments

8. Any other online service, facility, game, entertainment, function, utility, data, resource, software, communication tool or medium

The application uses a common instant messaging platform to provide most of the services, and conventional website technology to provide other services. The key differentiating software appears at login, when the website separates entrants according to the LAN to which they should be assigned. Thereafter, chat and instant messaging are in accordance with established practices.

The services are limited only to the network users. The same website address is used for all different networks, but each LAN shall exist within the website as a separate group with services and access limited as above.

### DRAWINGS AND DESCRIPTION

Various other objects, features and attendant advantages of the present invention will become fully appreciated as the same becomes better understood when considered in conjunction with the accompanying drawings.

FIGS. 1 and 2 illustrate the invention as applied to three different area networks (ANs). The actual invention is applicable to an unlimited number of different ANs.

FIG. 1 illustrates the separation of the ANs and the access from internal ANs to the WWW.

FIG. 2 illustrates the separation of the different AN users by the present invention, whereby each user can communicate with other users on the same network, can use services that are common to all participants in the website, and can additionally access services that are available only to his/her associated AN.

FIG. 3 shows the process of segmenting arriving users, and the assignment of each user to the appropriate segment.

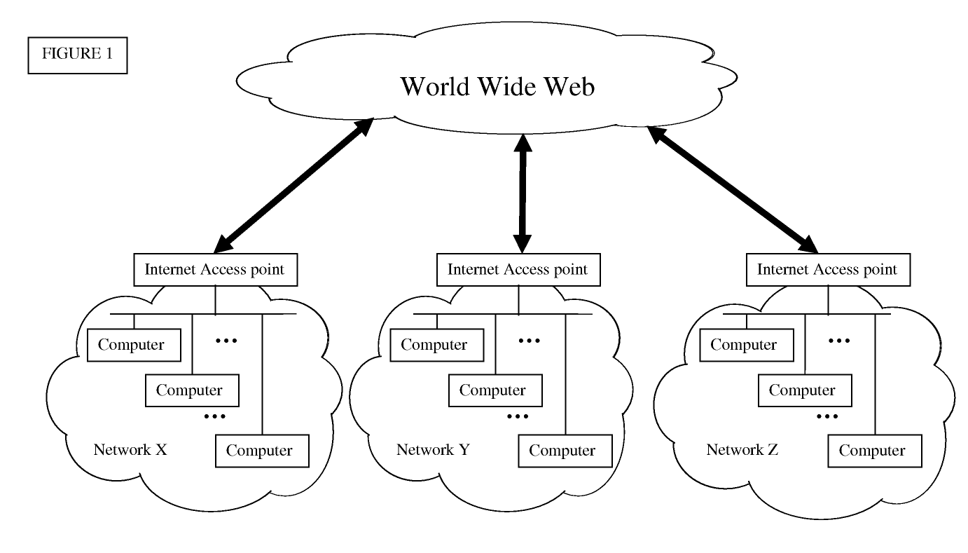

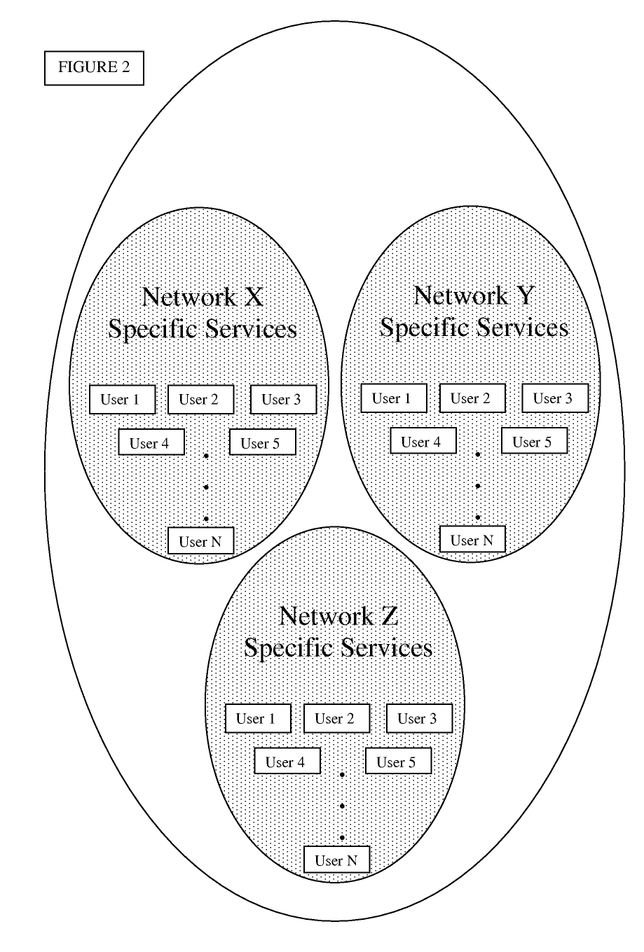

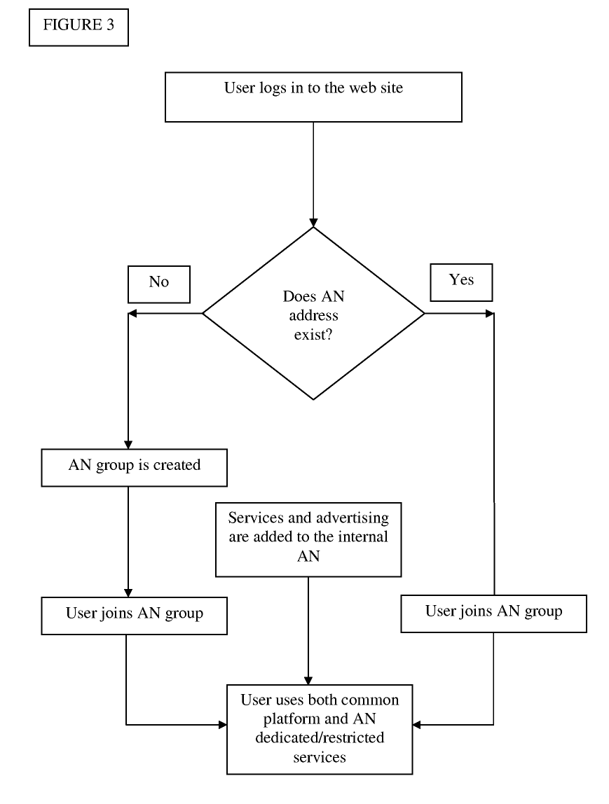

What is claimed is:

1. A method of assigning website's visitors to area networks.

2. The method of claim 1, wherein the assignment is done based on inputs sent manually by the user, using a network key, password or any other identification method.

3. The method of claim 1, wherein the assignment is done using network characteristics of computers networks.

4. A method using an internet website to provide dynamic online services and information which can vary from one area network to the other.

5. The method of claim 4, wherein the information and services are customized for each area network's users according to an area network assignment method.

6. The method of claim 4, wherein the information and services are limited to each area network's users according to an area network assignment method.

7. A method of providing computers network's administrators tools to customize internet web content and services for their area network.

8. The method of claim 7, wherein the same website can be used for different networks' services and information, whereas the services and information accessible on that website depends on the area network from which the website is browsed.

9. The method of claim 7, wherein the services and information provided by the area network administrator are to be used and view only by website visitors from that same area network.
